(19) United States
(12) Patent Application Publication
(10) Pub. No.: US 2025/0048285 A1
(43) Pub. Date: Feb. 6, 2025

(54) SYNCHRONIZING A POLICY CONTROL FUNCTION WITH A USER EQUIPMENT

(71) Applicant: QUALCOMM Incorporated, San Diego, CA (US)

(72) Inventors: Sunghoon KIM, San Diego, CA (US); Juan ZHANG, San Diego, CA (US); Hong CHENG, Basking Ridge, NJ (US)

(21) Appl. No.: 18/365,905

(22) Filed: Aug. 4, 2023

(51) Int. Cl. H04W 56/00; H04W 8/18

(52) U.S. Cl. CPC H04W 56/001; H04W 8/183

(57) ABSTRACT

Various aspects of the present disclosure generally relate to wireless communication. In some aspects, a user equipment (UE) may receive a first indication to report UE-local policy identifier information that is based at least in part on a policy control function (PCF) associated with a wireless network. The UE may transmit a second indication of a synchronization state between the UE-local policy identifier information and PCF policy identifier information. Numerous other aspects are described.

### FIELD OF THE DISCLOSURE

Aspects of the present disclosure generally relate to wireless communication and to techniques and apparatuses for synchronizing a policy control function with a user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first indication to report UE-local policy identifier information that is based at least in part on a policy control function (PCF) associated with a wireless network. The method may include transmitting a second indication of a synchronization state between the UE-local policy identifier information and PCF policy identifier information.

Some aspects described herein relate to a method of wireless communication performed by a network node. The method may include transmitting a first indication to report UE-local policy identifier information that is based at least in part on a PCF that is associated with a wireless network. The method may include receiving a second indication of a synchronization state between the UE-local policy identifier information and PCF policy identifier information.

Some aspects described herein relate to an apparatus for wireless communication at a UE. The apparatus may include one or more memories and one or more processors coupled to the one or more memories. The one or more processors may be configured, individually or collectively, to receive a first indication to report UE-local policy identifier information that is based at least in part on a PCF associated with a wireless network. The one or more processors may be configured, individually or collectively, to transmit a second indication of a synchronization state between the UE-local policy identifier information and PCF policy identifier information.

Some aspects described herein relate to an apparatus for wireless communication at a network node. The apparatus may include one or more memories and one or more processors coupled to the one or more memories. The one or more processors may be configured, individually or collectively, to transmit a first indication to report UE-local policy identifier information that is based at least in part on a PCF that is associated with a wireless network. The one or more processors may be configured, individually or collectively, to receive a second indication of a synchronization state between the UE-local policy identifier information and PCF policy identifier information.

Some aspects described herein relate to a non-transitory computer-readable medium that stores a set of instructions for wireless communication by a UE. The set of instructions, when executed by one or more processors of the UE, may cause the UE to receive a first indication to report UE-local policy identifier information that is based at least in part on a PCF associated with a wireless network. The set of instructions, when executed by one or more processors of the UE, may cause the UE to transmit a second indication of a synchronization state between the UE-local policy identifier information and PCF policy identifier information.

Some aspects described herein relate to a non-transitory computer-readable medium that stores a set of instructions for wireless communication by a network node. The set of instructions, when executed by one or more processors of the network node, may cause the network node to transmit a first indication to report UE-local policy identifier information that is based at least in part on a PCF that is associated with a wireless network. The set of instructions, when executed by one or more processors of the network node, may cause the network node to receive a second indication of a synchronization state between the UE-local policy identifier information and PCF policy identifier information.

Some aspects described herein relate to an apparatus for wireless communication. The apparatus may include means for receiving a first indication to report UE-local policy identifier information that is based at least in part on a PCF associated with a wireless network. The apparatus may include means for transmitting a second indication of a synchronization state between the UE-local policy identifier information and PCF policy identifier information.

Some aspects described herein relate to an apparatus for wireless communication. The apparatus may include means for transmitting a first indication to report UE-local policy identifier information that is based at least in part on a PCF that is associated with a wireless network. The apparatus may include means for receiving a second indication of a synchronization state between the UE-local policy identifier information and PCF policy identifier information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of an example of a core network, in accordance with the present disclosure.

FIG. 5 is a diagram illustrating an example of a wireless communication process between a network node and a UE, in accordance with the present disclosure.

FIG. 6 is a diagram illustrating an example of an information element (IE), in accordance with the present disclosure.

FIG. 7 is a diagram illustrating an example of an IE, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

A policy control function (PCF) at a core network may include one or more devices that provide a policy framework that incorporates network slicing, roaming, packet processing, and/or mobility management, among other examples. In some aspects, the PCF may provide the policy framework based at least in part on policy rules that are applied to communications between a user equipment (UE) and a network node. The PCF may transmit an entirety of a policy list to the UE instead of a partial and/or delta policy list that indicates differences between a first policy list maintained at the PCF and a second policy list at the UE. Transmitting the entirety of the policy may reduce a complexity in synchronizing the first policy list with the second policy list at the UE, but may increase a signaling overhead relative to transmitting a delta policy list and/or partial policy list.

At times, the UE may disconnect from a first PCF that is maintained at a first core network and connect to a second PCF that is maintained at a second core network, such as by changing locations that are serviced by different core network entities. Changing core network connections may result in the UE changing PCF connections and, subsequently, a UE-local policy list that is maintained by the UE being mismatched with a PCF policy list that is maintained by a current PCF the UE is connected to. Unsynchronized policy lists and, subsequently, unsynchronized policy rules between a PCF and a UE, may result in degraded performance of, and/or failed execution of, network slicing, roaming, packet processing, and/or mobility management provided by the PCF framework. In some aspects, the PCF and/or the UE may transmit an entirety of a policy list as described above to reduce a complexity of synchronizing the policy lists, resulting in increased a signaling overhead, reduced data throughput, and/or increased data transfer latencies within a wireless network.

Some techniques and apparatuses described herein provide synchronizing a PCF with a UE. In some aspects, a UE may receive a first indication to report UE-local policy identifier information that is based at least in part on a PCF associated with a wireless network. To illustrate, the first indication may specify to report UE-local policy section identifier information and/or UE-local tuple identifier information. Based at least in part on receiving the first indication, the UE may transmit a second indication of a synchronization state (e.g., a synchronized state and/or an unsynchronized state) between the UE-local policy identifier information and PCF policy identifier information. For instance, the UE may transmit a manage UE policy command complete message to indicate a synchronized state, a manage UE reject message to indicate an unsynchronized state, and/or a UE state indication message to indicate completion of a manage UE policy procedure and/or a synchronized state as described below.

In some aspects, a network node may transmit a first indication to report UE-local policy identifier information (e.g., policy section identifier information and/or tuple identifier information) that is based at least in part on a PCF that is associated with a wireless network. As one example, the network node may transmit a manage UE policy command message. Based at least in part on transmitting the first indication, the network node may receive a second indication of a synchronization state between the UE-local policy identifier information and PCF policy identifier information.

By indicating a request to report UE-local policy identifier information, a network node may instruct a UE to determine a synchronization state between a UE-local policy list and a PCF policy list. The UE may transmit an indication of the synchronization state to the network node and, based at least in part on receiving the indication of the synchronization state, the network node may update the PCF policy list and/or instruct the UE to update the UE-local policy list. Accordingly, the network node requesting the UE to report UE-local policy identifier information may enable the network node and the UE to maintain synchronized policy lists and mitigate decreased performance and/or failure to execute network slicing, roaming, packet processing, and/or mobility management provided by the PCF framework described above. Alternatively, or additionally, the UE transmitting an indication of a synchronization state associated with the policy lists may reduce a signaling overhead relative to the UE transmitting an entirety of a policy list as described below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a fifth generation (5G) or New Radio (NR) radio access technology (RAT), aspects of the present disclosure can be applied to other RATs, such as a 3G RAT, a 4G RAT, and/or a RAT subsequent to 5G (e.g., 6G).

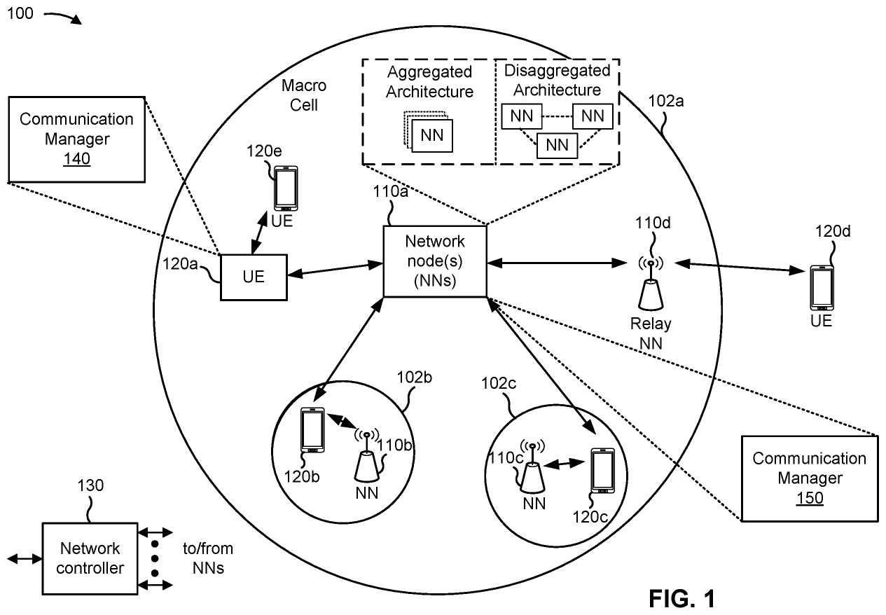

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNodeB (gNB) (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a first indication to report UE-local policy identifier information that is based at least in part on a PCF associated with a wireless network; and transmit a second indication of a synchronization state between the UE-local policy identifier information and PCF policy identifier information. Additionally, or alternatively, the communication manager 140 may perform one or more other operations described herein.

In some aspects, a network node (e.g., a network node 110) may include a communication manager 150. As described in more detail elsewhere herein, the communication manager 150 may transmit a first indication to report UE-local policy identifier information that is based at least in part on a PCF that is associated with a wireless network; and receive a second indication of a synchronization state between the UE-local policy identifier information and PCF policy identifier information. Additionally, or alternatively, the communication manager 150 may perform one or more other operations described herein.

As indicated above, FIG. 1 is provided as an example. Other examples may differ from what is described with regard to FIG. 1.

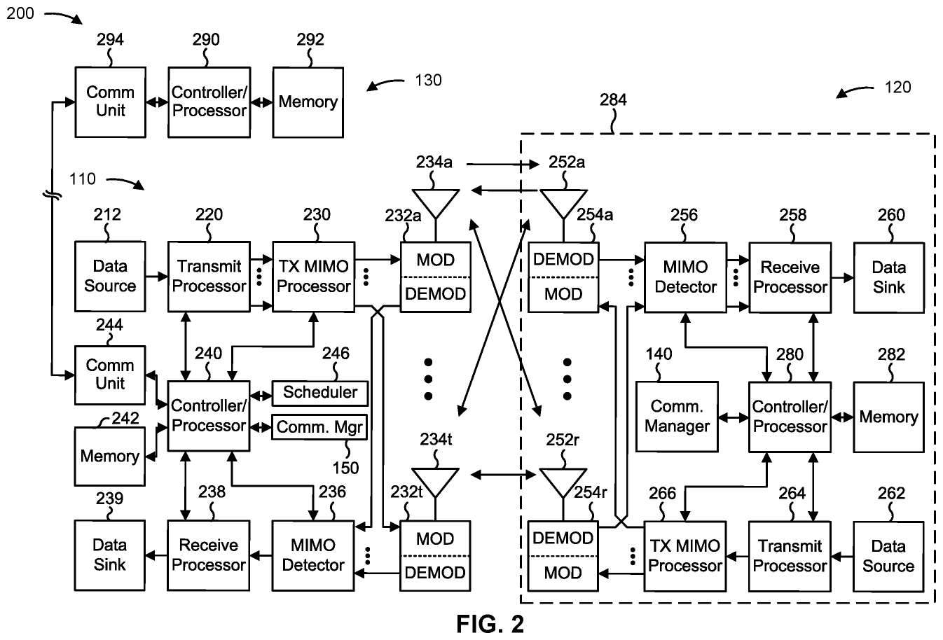

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

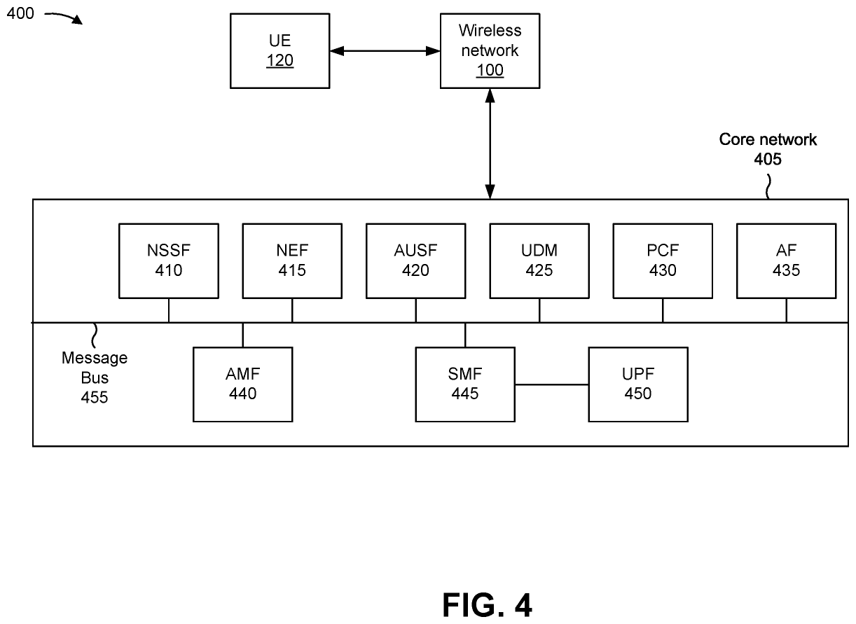

On the uplink, at the UE 120, a transmit processor 264 may receive and process data from a data source 262 and control information (e.g., for reports that include RSRP. RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

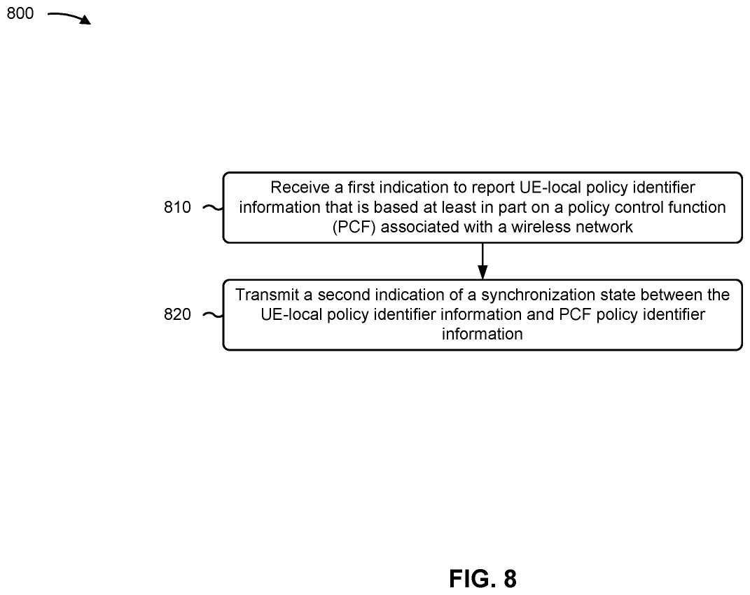

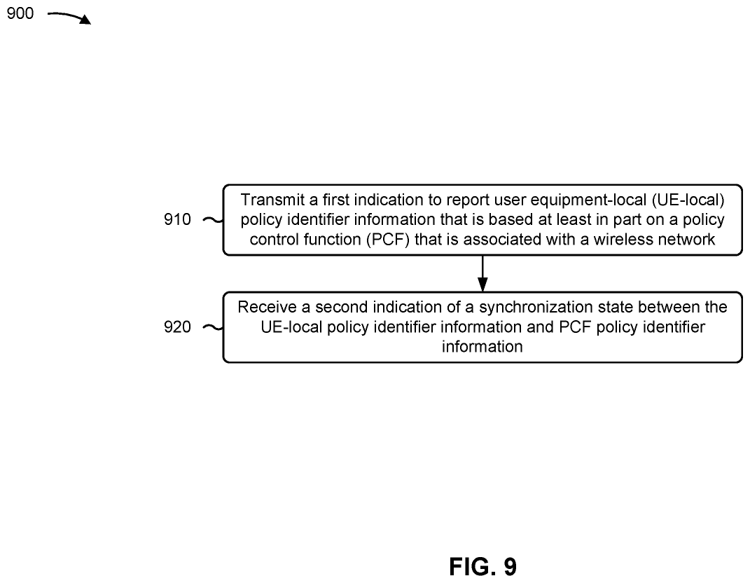

The controller/processor 240 of the network node 110, the controller/processor 280 of the UE 120, and/or any other component(s) of FIG. 2 may perform one or more techniques associated with synchronizing a PCF with a UE, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a first indication to report UE-local policy identifier information that is based at least in part on a PCF associated with a wireless network; and/or means for transmitting a second indication of a synchronization state between the UE-local policy identifier information and PCF policy identifier information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting a first indication to report UE-local policy identifier information that is based at least in part on a PCF that is associated with a wireless network; and/or means for receiving a second indication of a synchronization state between the UE-local policy identifier information and PCF policy identifier information. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

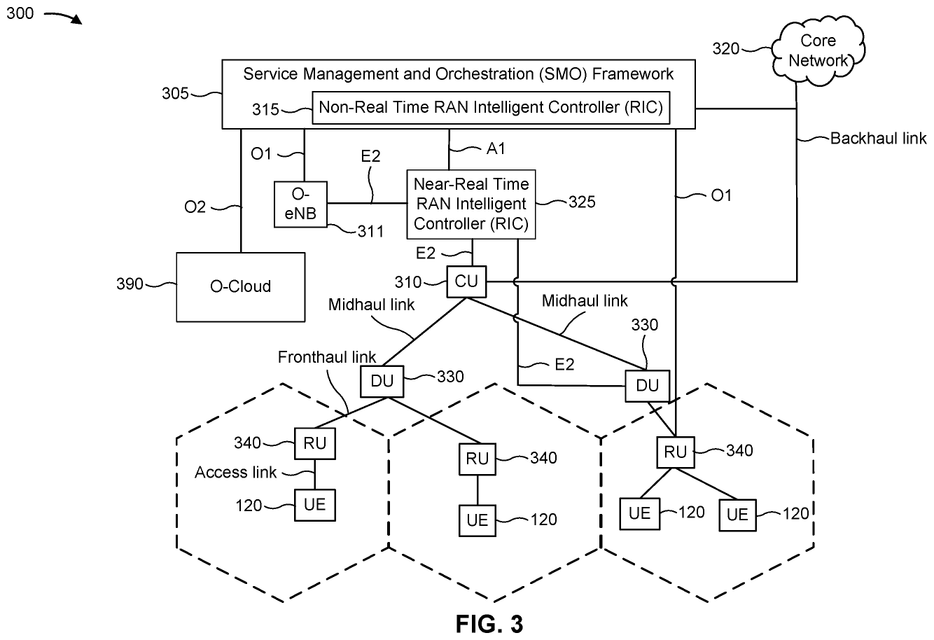

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram of an example 400 of a core network 405, in accordance with the present disclosure. As shown in FIG. 4, example 400 may include a UE 120, a wireless communication network 100, and a core network 405. Devices and/or networks of example 400 may interconnect via wired connections, wireless connections, or a combination thereof.

The wireless communication network 100 may support, for example, a cellular RAT. The network 100 may include one or more network nodes, such as base stations (e.g., base transceiver stations, radio base stations, node Bs, eNBs, gNBs, base station subsystems, cellular sites, cellular towers, access points, TRPs, radio access nodes, macrocell base stations, microcell base stations, picocell base stations, femtocell base stations, or similar types of devices) and other network nodes that can support wireless communication for the UE 120. The network 100 may transfer traffic between the UE 120 (e.g., using a cellular RAT), one or more network nodes (e.g., using a wireless interface or a backhaul interface, such as a wired backhaul interface), and/or the core network 405. The wireless communication network 100 may provide one or more cells that cover geographic areas.

In some aspects, the wireless communication network 100 may perform scheduling and/or resource management for the UE 120 covered by the network 100 (e.g., the UE 120 covered by a cell provided by the wireless communication network 100). In some aspects, the wireless communication network 100 may be controlled or coordinated by a network controller (e.g., network controller 130 of FIG. 1), which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 405 may include an example functional architecture in which systems and/or methods described herein may be implemented. For example, the core network 405 may include an example architecture of a 5G next generation (NG) core network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of functional elements. The functional elements may include, for example, a network slice selection function (NSSF) 410, a network exposure function (NEF) 415, an authentication server function (AUSF) 420, a unified data management (UDM) component 425, a PCF 430, an application function (AF) 435, an access and mobility management function (AMF) 440, a session management function (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 410 may determine a set of network slice policies to be applied at the wireless communication network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples. In some aspects, the AMF may request the NSSF 410 to select network slice instances for the UE 120, e.g., at least partially in response to a request for data service from the UE 120.

The SMF 445 may include one or more devices that support the establishment, modification, and release of communication sessions in the wireless telecommunications system. For example, the SMF 445 may configure traffic steering policies at the UPF 450 and/or enforce user equipment internet protocol (IP) address allocation and policies, among other examples. In some aspects, the SMF 445 may provision the network slice instances selected by the NSSF 410 for the UE 120.

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane QoS, among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

In some aspects, the PCF 430 may transmit an entirety of a policy list to a UE (e.g., a UE 120) instead of a partial and/or delta policy list that indicates differences between a first policy list maintained at the PCF 430 and a second policy list at the UE. Transmitting the entirety of the policy may reduce a complexity in synchronizing the first policy list with the second policy list at the UE, but may increase a signaling overhead relative to transmitting a delta policy list and/or partial policy list. Each policy list may include one or more policy rules (e.g., one or more URSP rules) that are associated with communicating in the wireless network 100 and/or one or more policy identifiers (e.g., a policy section identifier and/or tuple identifier as described below). At times, the UE may disconnect from a first PCF that is maintained at a first core network and connect to a second PCF that is maintained at a second core network. To illustrate, based at least in part on UE mobility, the UE may change from a first location that is associated with the first core network to a second location that is associated with the second core network. Changing core network connections may result in the UE changing PCF connections and, subsequently, a UE-local policy list (e.g., the second policy list at the UE) being mismatched with a PCF policy list (e.g., maintained by the second PCF). As one example, the first PCF at the first core network may not communicate information about a first PCF policy list at the first PCF and/or the UE-local policy list the second PCF at the second core network. Accordingly, a second PCF policy list maintained by the second PCF may be unsynchronized with the UE-local policy list at the UE. For instance, the second PCF may transmit an instruction to remove a policy section (and/or one or more policy rules included in the policy section) from the UE-local policy list, such as by transmitting remove instruction and a policy section identifier that is associated with the policy section. Based at least in part on the second PCF policy list being unsynchronized with the UE-local polity list, the indicated policy section may be missing from the UE-local policy list. Unsynchronized policy lists and, subsequently, unsynchronized policy rules between a PCF and a UE, may result in degraded performance of, and/or failed execution of, network slicing, roaming, packet processing, and/or mobility management provided by the PCF framework described above.

Alternatively, or additionally, the PCF 430 and/or a UE (e.g., a UE 120) may maintain tuples of policy rules and/or policy sections, where “tuple” may denote a single item that includes multiple policy rules (e.g., URSP rules) and/or a policy section with the multiple policy rules. For instance, a tuple may be associated with three policy rules and/or a first policy section that includes the three policy rules, five policy rules and/or a second policy section that includes the five policy rules, or ten policy rules and/or a third policy section that includes the ten policy rules. Each tuple may be associated with and/or referenced through a tuple identifier. In some aspects, the PCF 430 may indicate a tuple identifier to the UE, and the UE may communicate in a wireless network based at least in part on using the policy rules and/policy sections included in a tuple that is referenced by the tuple identifier. In some aspects, the PCF 430 may indicate multiple tuples to the UE, and each tuple may be associated with a respective public land mobile network (PLMN). As the UE changes locations, the UE may change PLMNs and, subsequently, be directed to use a particular tuple and/or the policy rules of the particular tuple that is associated with a PLMN (e.g., a current PLMN and/or a visited PLMN (VPLMN)). In a similar manner as described above, a UE-local policy list of tuples may be mismatched with a PCF policy list of tuples that are maintained by the second PCF. A PCF policy list of tuples that is unsynchronized with a UE-local policy list of tuples may result in degraded performance of, and/or failed execution of, network slicing, roaming, packet processing, and/or mobility management provided by the PCF framework described above. In some aspects, the UE may transmit an entirety of policy sections and/or tuples included in the UE-local polity list, resulting in increased a signaling overhead, reduced data throughput, and/or increased data transfer latencies within a wireless network.

Some techniques and apparatuses described herein provide synchronizing a policy control function with a UE. In some aspects, a UE may receive a first indication to report UE-local policy identifier information that is based at least in part on a PCF associated with a wireless network. To illustrate, the first indication may specify to report UE-local policy section identifier information and/or UE-local tuple identifier information. Based at least in part on receiving the first indication, the UE may transmit a second indication of a synchronization state (e.g., a synchronized state and/or an unsynchronized state) between the UE-local policy identifier information and PCF policy identifier information. For instance, the UE may transmit a manage UE policy command complete message to indicate a synchronized state, a manage UE reject message to indicate an unsynchronized state, and/or a UE state indication message to indicate completion of a manage UE policy procedure and/or a synchronized state as described below.

In some aspects, a network node may transmit a first indication to report UE-local policy identifier information (e.g., policy section identifier information and/or tuple identifier information) that is based at least in part on a PCF that is associated with a wireless network. As one example, the network node may transmit a manage UE policy command message. Based at least in part on transmitting the first indication, the network node may receive a second indication of a synchronization state between the UE-local policy identifier information and PCF policy identifier information.

By indicating a request to report UE-local policy identifier information, a network node may instruct a UE to determine a synchronization state between a UE-local policy list and a PCF policy list. The UE may transmit an indication of the synchronization state to the network node and, based at least in part on receiving the indication of the synchronization state, the network node may update the PCF policy list and/or instruct the UE to update the UE-local policy list. As one example, the network node may add and/or remove one or more entries in the PCF policy list based at least in part on the UE indicating an unsynchronized state. Alternatively, or additionally, the network node may direct the UE to update one or more entries in the UE-local policy list based at least in part on the UE indicating an unsynchronized state, such as by transmitting a first instruction to add a policy entry (e.g., a policy section and/or a tuple) and/or a second instruction to remove a policy entry. Accordingly, the network node requesting the UE to report UE-local policy identifier information may enable the network node and the UE to maintain synchronized policy lists and mitigate decreased performance and/or failure to execute network slicing, roaming, packet processing, and/or mobility management provided by the PCF framework described above.

Alternatively, or additionally, the UE transmitting an indication of a synchronization state associated with the policy lists may reduce a signaling overhead relative to the UE transmitting an entirety of a policy list. For instance, the UE may indicate a synchronized state based at least in part on transmitting an empty policy list and/or the UE may indicate unsynchronized policy list entries (e.g., only the unsynchronized policy list entries) instead of an entirety of the policy list. The reduced signaling overhead may result in increased data throughput and/or decreased data transfer latencies within a wireless network.

As indicated above, FIG. 4 is provided as an example. Other examples may differ from what is described with regard to FIG. 4.

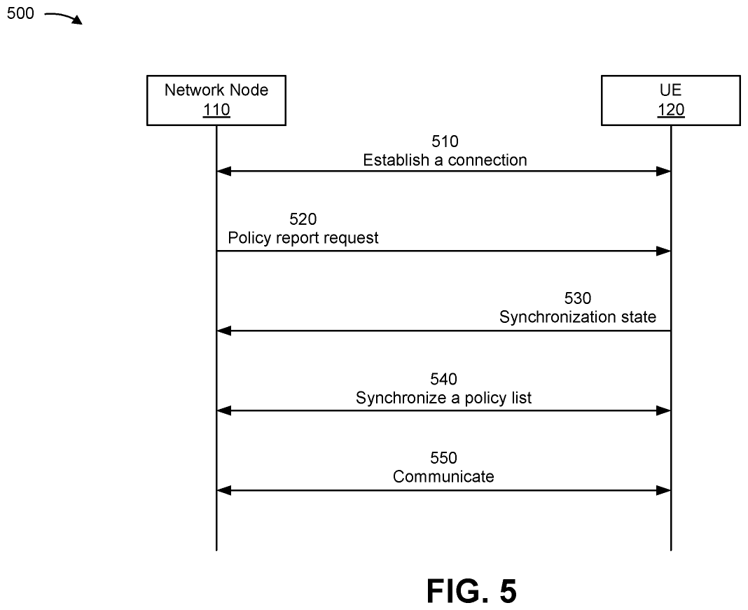

FIG. 5 is a diagram illustrating an example 500 of a wireless communication process between a network node (e.g., the network node 110) and a UE (e.g., the UE 120), in accordance with the present disclosure.

As shown by reference number 510, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE being tolerant of communication delays, and the network node 110 may transmit an activation of the configuration via Layer 2 signaling and/or Layer 1 signaling at a second point in time associated with the UE being intolerant to communication delays.

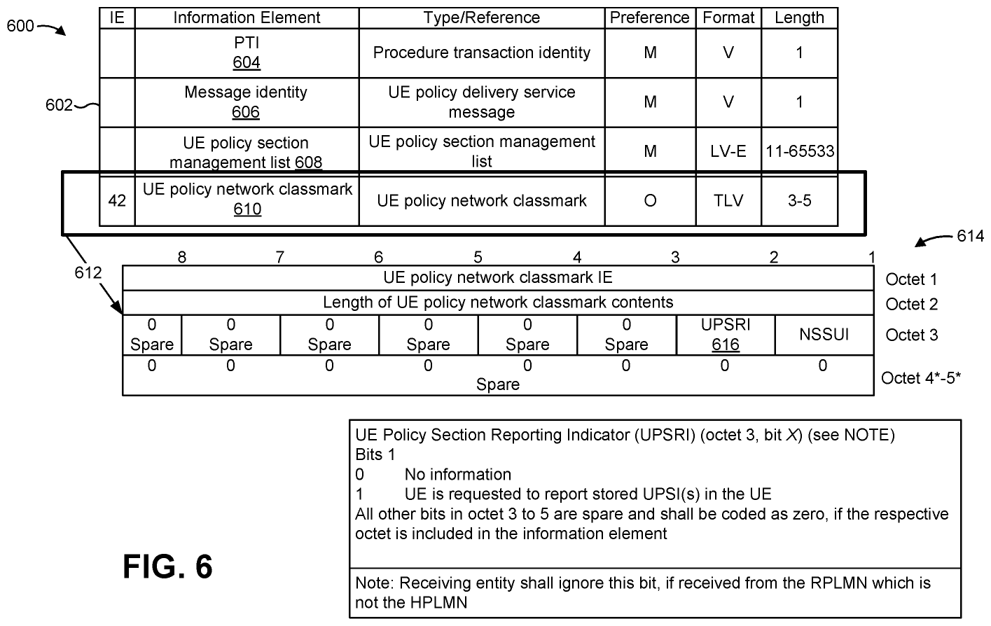

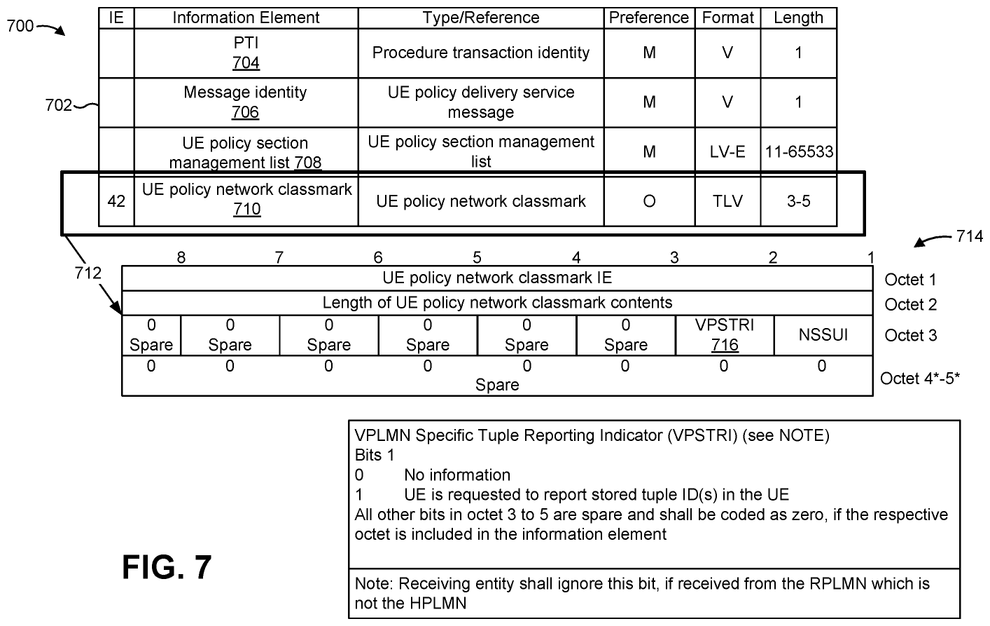

As shown by reference number 520, the network node 110 may transmit, and the UE 120 may receive, a policy report request. For example, and as described below with regard to FIG. 6 and FIG. 7, the network node 110 may transmit a manage UE policy command message that includes a UE policy network classmark information element (IE). The network node 110 may transmit the manage UE policy command message in any combination of Layer 3 signaling, Layer 2 signaling, and/or Layer 1 signaling. In some aspects, the UE policy network classmark IE includes and/or indicates the policy report request. To illustrate, the UE policy network classmark IE may include a UE policy section reporting indicator (UPSRI) field and/or a VPLMN specific tuple policy reporting indicator (VPSTRI) field, and the network node 110 may set the UPSRI field and/or the VPSTRI field to a value that indicates the policy report request. For instance, the network node 110 may set the UPSRI field to a first value (e.g., “1”) that indicates a request to report one or more UE policy section identifiers (UPSIs) that are stored as at least part of the UE-local policy identifier information. Alternatively, or additionally, the network node 110 may set the UPSRI field to a second value (e.g., “0”) that indicates that the network node 110 does not request a policy report associated with the UPSI(s). As another example, the network node 110 may set the VPSTRI field to the first value (e.g., “1”) to indicates a request to report one or more tuple identifiers included in the UE-local policy identifier information and/or may set the VPSTRI field to the second value (e . . . , “0”) to indicate that the network node 110 does not request a policy report that includes the tuple identifiers. In some aspect, the VPSTRI field being set to the first value may implicitly indicate a request to report one or more tuple identifiers that are associated with a current PLMN (e.g., a VPLMN) and/or to exclude, from the report, one or more tuple identifiers that are not associated with the current PLMN. In other aspects, the VPSTRI field being set to the first value may implicitly indicate to report all tuple identifiers that are included in the UE-local policy identifier information (e.g., independent of an associated VPLMN).

The manage UE policy command message transmitted by the network node 110 may include an indication of one or more instructions that are associated with the UE-local policy identifier information, such as a first instruction associated with adding a policy rule and/or policy identifier (e.g., a UPSI, a tuple identifier, and/or a policy section identifier) to the UE-local policy identifier information, a second instruction associated with removing a policy rule and/or a policy identifier from the UE-local policy identifier information, and/or a third instruction associated with modifying a policy rule and/or a policy identifier in the UE-local policy identifier information. Alternatively, or additionally, the manage UE policy command message may indicate to perform a manage UE policy procedure and/or may include an identifier associated with the manage UE policy procedure, such as a procedure transaction identity (PTI). Based at least in part on receiving an instruction, the UE 120 may transmit an indication of a synchronization state as described below. Alternatively, or additionally, the UE 120 may transmit an indication of the synchronization state based at least in part on receiving the indication of a manage UE policy procedure.

As shown by reference number 530, the UE 120 may transmit, and the network node 110 may receive, an indication of a synchronization state that is associated with UE-local policy identifier information and PCF policy identifier information. In some aspects, the UE 120 may indicate the synchronization state based at least in part on transmitting any combination of a manage UE policy command complete message, a mange UE reject message, and/or a UE state indication message as described below. Alternatively, or additionally, the UE 120 may indicate one or more policy identifiers (e.g., a policy section identifier and/or a tuple identifier) in the message, and the one or more policy identifiers may be based at least in part on the UE-local policy identifier information stored at the UE 120. For instance, the UE 120 may indicate one or more policy identifiers included the UE-local policy identifier information that the UE 120 identifies as being unsynchronized with the PCF policy identifier information and/or may refrain from reporting one or more policy identifiers included the UE-local policy identifier information that the UE 120 identifies as being synchronized with the PCF policy identifier information.

As one example, the manage UE policy command message may include one or more instructions as described above. Based at least in part on performing each instruction successfully (e.g., without error), the UE 120 may transmit a manage UE policy command complete message. Examples of successfully performing an instruction include the UE 120 locating a first indicated policy in the UE-local policy identifier information and removing the first indicated policy from the UE-local policy identifier information and/or the UE adding a second indicated policy to the UE-local policy identifier information without exceeding a limit condition. Based at least in part on performing each instruction without error and/or successfully, the UE 120 may determine that the UE-local policy identifier information and the PCF policy identifier information are synchronized. Accordingly, the UE 120 may transmit the manage UE policy command complete message to implicitly indicate a synchronized state between the UE-local policy identifier information and the PCF policy identifier information. Alternatively, or additionally, the UE 120 may refrain from including any policy identifier information (e.g., a policy section identifier and/or a tuple identifier) in the manage UE policy command complete message. Based at least in part on failing to perform at least one instruction successfully (e.g., the UE 120 encounters at least one error during the execution of an instruction), the UE 120 may transmit a manage UE reject message to implicitly indicate an unsynchronized state between the UE-local policy identifier information and the PCF policy identifier information. In some aspects, the UE 120 may include a policy section identifier, a tuple identifier, a UPSI, and/or URSP configuration in the manage UE reject message, such as a policy identifier associate with the UE 120 encountering an error.

Alternatively, or additionally, the manage UE policy command message may indicate and/or be associated with a manage UE policy procedure and/or a PTI. In some aspects, the UE 120 may transmit a UE state indication message based at least in part on completion of the manage UE policy procedure and detecting that the UE-local policy identifier list and the PCF identifier list are unsynchronized. Accordingly, the UE 120 may transmit the UE state indication message to indicate an unsynchronized state between the UE-local policy identifier information the PCF policy identifier information. For instance, the UE 120 may detect the unsynchronized state based at least in part on detecting that the UE-local policy identifier information does not include a policy section identifier and/or tuple identifier indicated by the manage UE policy command message. As another example, the manage UE policy command message may indicate to add a policy section identifier and/or tuple identifier to the UE-local policy identifier information, and, prior to adding the policy section identifier and/or tuple identifier to the UE-local policy identifier information, the UE 120 may determine that the UE-local policy identifier information includes a maximum number of entries. Accordingly, the UE 120 may detect the unsynchronized state based at least in part on receiving an instruction to add a policy section identifier to the UE-local policy identifier information and determining that the UE-local identifier information already includes the maximum number of entries, and, subsequently, transmit the UE state indication message to indicate the unsynchronized state.

In some aspects, the UE 120 may transmit the UE state indication (e.g., to indicate an unsynchronized state) based at least in part on detecting that a location associated with the UE 120 satisfies a distance threshold and/or that a distance and/or amount of location change satisfies the distance threshold. To illustrate, the UE 120 may determine that a change in location (e.g., that satisfies the distance threshold) may be associated with the UE 120 connecting to a different PCF. Accordingly, the UE 120 may transmit the UE state indication to trigger a policy synchronization with the PCF. Alternatively, or additionally, the UE 120 may transmit the UE state indication (e.g., to indicate an unsynchronized state) based at least in part on detecting that a configuration of the UE-local policy identifier information has remained unchanged for a time span and/or a duration that satisfies a time threshold. In some aspects, the UE state indication may include at least some of the UE-local policy identifier information, such as one or more policy section identifiers, one or more tuple identifiers, and/or one or more UPSI(s) (e.g., included in a policy section and/or a tuple).

In some aspects, the UE 120 may determine that the UE-local policy identifier information and the PCF policy identifier information have an unsynchronized state based at least in part on detecting that the UE-local policy identifier information does not include a tuple identifier (e.g., indicated by the network node 110) that is associated with a current PLMN (e.g., a VPLMN). Accordingly, the UE 120 may transmit the UE state indication based at least in part on detecting and/or determining the unsynchronized state based at least in part on the tuple identifier and/or the current PLMN. The UE 120 may include one or more tuple identifiers and/or VPLMN-specific URSP configuration information (e.g., specific to the current PLMN) in the UE state indication message. At times, and in a similar manner as described above with regard to a policy section identifier, the manage UE policy command message may indicate an instruction to add a tuple identifier to the UE-local policy identifier information, and the UE 120 may detect, prior to adding the tuple identifier to the UE-local policy identifier information, that the UE-local policy identifier information includes a maximum number of entries. Based at least in part on the UE-local policy identifier information including the maximum number of entries (e.g., a maximum number of tuple identifiers) and receiving the instruction to add a tuple identifier, the UE 120 may determine that the UE-local policy identifier information and the PCF policy identifier information have an unsynchronized state.

In some aspects, the UE 120 may determine that the UE-local policy identifier information and the PCF policy identifier information have a synchronized state. As one example, the UE 120 may detect zero mismatches between the UE-local policy identifier information and the PCF policy identifier information. That is, the UE 120 may detect and/or determine that each tuple identifier and/or each policy section identifier included in the UE-local policy identifier information is included in the PCF policy identifier information, such as by comparing the UE-local policy identifier information with PCF policy identifier information indicated by the manage UE policy command message. Accordingly, and based at least in part on detecting zero mismatches, the UE 120 may determine that the UE-local policy identifier information and the PCF policy information have a synchronized state.

As another example, the UE 120 may receive an instruction to store a policy identifier (e.g., a tuple identifier and/or a policy section identifier) in the UE-local policy identifier information. Based at least in part on the UE-local policy identifier information being empty (e.g., prior to storing the policy identifier), the UE 120 may determine that the UE-local policy identifier information and the PCF policy identifier information have a synchronized state. Alternatively, or additionally, the UE 120 may receive an instruction to store a new policy section (e.g., based at least in part on receiving the policy section identifier) that is currently not included in the UE-local policy identifier information, and the UE 120 may determine that the UE-local policy identifier information and the PCF policy identifier information have a synchronized state. In some aspects, the UE 120 may receive a first instruction to remove a policy section (e.g., based at least in part on receiving the respective policy section identifier), a second instruction to update the policy section (e.g., one or more policy rules within the policy section), and/or a third instruction to replace the policy section. Based at least in part on locating the policy section and/or policy section identifier in the UE-local policy identifier information, the UE may determine that the UE-local policy identifier information and the PCF policy identifier information have a synchronized state.

In some aspects, to indicate a synchronized state between the UE-local policy identifier information and the PCF identifier information, the UE 120 may transmit an empty UPSI list. That is, the UE 120 may transmit the empty UPSI list to indicate the synchronized state and/or may transmit a non-empty UPSI list to indicate an unsynchronized state. For instance, the non-empty UPSI list may include a UPSI that the UE 120 determines as being missing from the UE-local policy identifier information or the PCF policy identifier information. Transmitting an empty UPSI list and/or an empty policy identifier list may reduce signaling overhead, increase data throughput in a wireless network, and/or decrease a data transfer latency. As described above, the UE 120 may transmit a UPSI identifier and/or a policy section identifier to indicate an unsynchronized state, and/or refrain from transmitting a UPSI identifier and/or policy section identifier to indicate a synchronized state.

In some aspects, the UE 120 may transmit an indication of a tuple identifier. For instance, and as described above, the manage UE policy command message may specify to report tuple policy information. Alternatively, or additionally the manage UE policy command message may include a policy section instruction, such as a first instruction to add a policy section (e.g., a policy section identifier and/or a policy rule) to the UE-local policy identifier information, a second instruction to remove a policy section from the UE-local policy identifier information, and/or a third instruction to modify a policy section in the UE-local policy identifier information. In some aspects, the UE 120 may determine and/or identify that a tuple in the UE-local policy identifier information is affected by the policy section instruction, such as a tuple that includes the policy section identifier (and/or one or more associated policy rules) that the UE 120 has been instructed to remove. Based at least in part on identifying the tuple is associated with the policy section instruction, the UE 120 may transmit the tuple identifier that is affected by the policy section instruction to indicate an unsynchronized state. Alternatively, or additionally, the UE 120 may determine and/or identify that no tuple in the UE-local policy identifier information is affected by the policy section instruction, and the UE 120 may transmit an empty tuple identifier list to indicate a synchronized state. Transmitting an empty tuple identifier list (and/or an empty policy section identifier list as described above) may reduce signaling overhead, increase data throughput in a wireless network, and/or decrease a data transfer latency. That is, in some aspects, the UE 120 may transmit a tuple identifier (and/or policy section identifier) to indicate an unsynchronized state, and/or refrain from transmitting a tuple identifier to indicate a synchronized state.

As described above, the manage UE policy command message may include a VPSTRI field that indicates a request to report one or more tuple identifiers that are associated with a current PLMN (e.g., a VPLMN) and/or to not report tuple identifier(s) that is associated with a non-current PLMN. Accordingly, the UE 120 may transmit one or more tuple identifiers that are associated the current PLMN (e.g., to indicate an unsynchronized state) and/or may refrain from transmitting one or more tuple identifiers that are associated with a non-current PLMN.

As shown by reference number 540, the network node 110 and the UE 120 may synchronize a policy list. For example, the network node 110 may direct the UE 120 to remove, from the UE-local policy identifier information, one or more policy identifiers (e.g., a policy section identifier and/or tuple identifier) indicated by the UE 120 as described with regard to reference number 530. As another example, the network node 110 may add the one or more policy identifiers to PCF policy identifier information.

As shown by reference number 550, the network node 110 and the UE 120 may communicate based at least in part on the policy list. For example, the network node 110 and the UE 120 may communicate with one another using any combination of network slicing, roaming, packet processing, and/or mobility management provided by the PCF framework.

By indicating a request to report UE-local policy identifier information, a network node may instruct a UE to determine a synchronization state between a UE-local policy list (e.g., UE-local policy identifier information) and a PCF policy list (e.g., PCF policy identifier information). The UE may transmit an indication of the synchronization state to the network node and, based at least in part on receiving the indication of the synchronization state, the network node may update the PCF policy list and/or instruct the UE to update the UE-local policy list. For instance, the network node may synchronize the PCF policy list with the UE-local policy list based at least in part on the UE indicating an unsynchronized state. Accordingly, the network node requesting the UE to report UE-local policy identifier information may enable the network node and the UE to maintain synchronized policy lists and mitigate decreased performance and/or failure to execute network slicing, roaming, packet processing, and/or mobility management provided by the PCF framework described above. In some aspects, the UE transmitting an indication of a synchronization state associated with the policy lists may reduce a signaling overhead, such as by the UE refraining from transmitting an entirety of a policy list, and the reduced signaling overhead may result in increased data throughput and/or decreased data transfer latencies within a wireless network.

As indicated above, FIG. 5 is provided as an example. Other examples may differ from what is described with regard to FIG. 5.

FIG. 6 is a diagram illustrating an example 600 of an IE, in accordance with the present disclosure.

The example 600 includes an IE 602 that may be used to communicate one or more policy messages. To illustrate, a manage UE policy command message as described with regard to FIG. 5 may be based at least in part on the IE 602. As one example, each field included in the IE 602 may be included in the manage UE policy command message.

In the example 600, the IE 602 includes a procedure transaction identity field 604 (shown as PTI 604) that may be used to indicate a UE policy procedure identifier, such as a manage UE policy procedure as described with regard to FIG. 5. In FIG. 6, the procedure identity field 604 has a length of one octet (e.g., eight bits), but examples may configure the procedure transaction identify field 604 with other lengths. The IE 602 may also include a message identify field 606 that may be used to indicate a message type associated with the manage UE policy procedure. As one example, the message identity field 606 may be set to a value that indicates a manage UE policy command message type. That is, a network node transmitting a message that is based at least in part on the IE 602 may set the message identity field 606 to a value that indicates the message is a manage UE policy command message. In FIG. 6, the message identity field 606 has a length of one octet, but may have a different length in other examples.

The IE 602 may include a UE policy section management list field 608, that may be of variable length. For instance, and as shown by FIG. 6, the UE policy section management list field 608 may range in length between 11 octets to 65533 octets. The variation in length may be based at least in part on a number of entries included the UE policy section management list field 608. For instance, a network node (e.g., a network node 110) transmitting a message that is based at least in part on the IE 602 may set the UE policy section management list field 608 to one or more policy section identifiers that are associated with a PCF policy identifier list. Alternatively, or additionally, the network node may set the UE policy section management list field 608 to one or more policy section identifiers that are associated with an instruction (e.g., remove, add, and/or modify).

As shown by FIG. 6, the IE 602 may include a UE policy network classmark field 610 that may be configured to indicate policy information. To illustrate, and as shown by reference number 612, the UE policy network classmark field 610 may include multiple fields and/or may span multiple octets as shown by reference number 614. Each field may be set to respective values that indicate policy information. For instance, a third octet of the UE policy network classmark field 610 shown by FIG. 6 includes a UPSRI field 616. More particularly, the UPSRI field 616 is located in a second least significant bit (LSB) of the third octet. However, other examples may include the UPSRI field 616 being located in a different octet and/or at a different bit position of the UE policy network classmark field 610 and/or the IE 602. In some aspects, a network node transmitting a message that is based at least in part on the IE 602 may set the UPSRI field 616 to a first value (e.g., “1”) to indicate a request to report stored UPSI(s) at the UE (e.g., UPSI(s) associated with UE-local policy identifier information) and a second value (e.g., “0”) to indicate that no report is being requested by the network node. Alternatively, or additionally, the first value may indicate to report a synchronization state between UE-local policy identifier list and PCF policy identifier information, and the second value may indicate to not report the synchronization state.

As indicated above, FIG. 6 is provided as an example. Other examples may differ from what is described with regard to FIG. 6.

FIG. 7 is a diagram illustrating an example 700 of an IE, in accordance with the present disclosure.

The example 700 includes an IE 702 that may be used to communicate one or more policy messages, such as a manage UE policy command message as described with regard to FIG. 5. To illustrate, each field included in the IE 702 may be included in the manage UE policy command message. Alternatively, or additionally, the IE 702 may include similar fields as those described with regard to FIG. 6.

As one example, and as shown by FIG. 7, the IE 702 may include a procedure transaction identity field 704 (shown as PTI 704) that indicates a procedure identifier, a message identify field 706 that indicates a message type associated with the manage UE policy procedure, and/or a UE policy section management list field 708 that indicates one or more policy section identifiers that are associated with a PCF policy identifier list and/or an instruction as described above.

As shown by FIG. 7, the IE 702 may include a UE policy network classmark field 710 that indicates policy information. For instance, and as shown by reference number 712, the UE policy network classmark field 710 may include multiple fields and/or may span multiple octets as shown by reference number 714. In the example 700, a third octet of the UE policy network classmark field 710 includes a VPSTRI field 716, and the VPSTRI field 716 is located in a second LSB of the third octet. Other examples may include the VPSTRI field 716 being located in a different octet and/or a different bit position of the UE policy network classmark field 710 and/or the IE 702. In some aspects, a network node (e.g., a network node 110) transmitting a message that is based at least in part on the IE 702 may set the VPSTRI field 716 to a first value (e.g., “1”) to indicate a request to report stored tuples at the UE (e.g., tuple identifiers associated with UE-local policy identifier information) and a second value (e.g., “0”) to indicate that no report is being requested by the network node. Alternatively, or additionally, the first value may indicate to report a synchronization state between the UE-local policy identifier information and the PCF policy identifier information, and the second value may indicate to not report the synchronization state.

In some aspects, the UE policy network classmark field 710 may additionally include a UPSRI field 616 as described with regard to FIG. 6. Alternatively, or additionally, the UE policy network classmark field 610 as described with regard to FIG. 6 may additionally include the VPSTRI field 716. That is, the UE policy network classmark field 610 and/or the UE policy network classmark field 710 may include both the UPSRI field 616 and the VPSTRI field 716, and at least one of the UPSRI field 616 and the VPSTRI field 716 may be positioned at a different bit location than shown by FIG. 6 and FIG. 7, respectively.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with synchronizing a policy control function with UE.

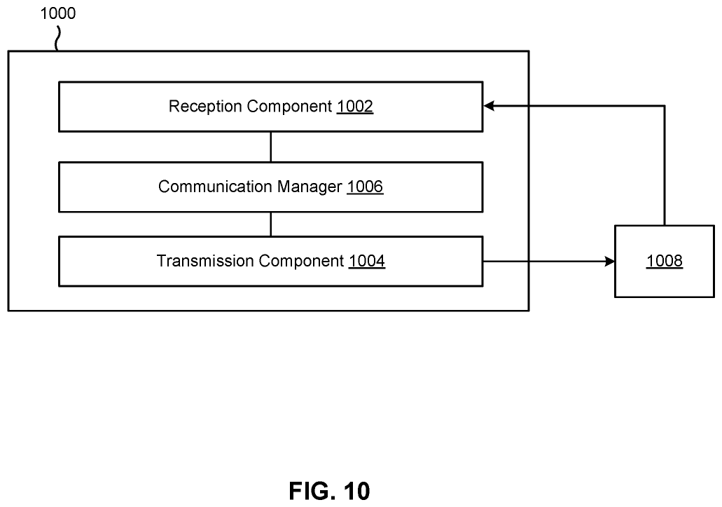

As shown in FIG. 8, in some aspects, process 800 may include receiving a first indication to report UE-local policy identifier information that is based at least in part on a PCF associated with a wireless network (block 810). For example, the UE (e.g., using reception component 1002 and/or communication manager 1006, depicted in FIG. 10) may receive a first indication to report UE-local policy identifier information that is based at least in part on a PCF associated with a wireless network, as described above.

As further shown in FIG. 8, in some aspects, process 800 may include transmitting a second indication of a synchronization state between the UE-local policy identifier information and PCF policy identifier information (block 820). For example, the UE (e.g., using transmission component 1004 and/or communication manager 1006, depicted in FIG. 10) may transmit a second indication of a synchronization state between the UE-local policy identifier information and PCF policy identifier information, as described above.

Process 800 may include additional aspects, such as any single aspect or any combination of aspects described below and/or in connection with one or more other processes described elsewhere herein.

In a first aspect, receiving the first indication includes receiving a manage UE policy command message that includes a UE policy network classmark IE, and the UE policy network classmark IE includes the first indication.

In a second aspect, the UE policy network classmark IE includes a UPSRI field, and the first indication includes the UPSRI field being set to a value that indicates to report one or more policy section identifiers included in the UE-local policy identifier information.

In a third aspect, the UE policy network classmark IE includes a VPSTRI field, and the first indication includes the VPSTRI field being set to a value that indicates to report one or more tuple identifiers included in the UE-local policy identifier information.

In a fourth aspect, the value indicates to report a first tuple identifier that is associated with a current PLMN, and the value indicates to not report a second tuple identifier that is associated with a non-current PLMN.

In a fifth aspect, process 800 includes receiving, as at least part of a manage UE policy command message, a third indication of one or more instructions that are associated with the UE-local policy identifier information, transmitting the second indication is based at least in part on the one or more instructions.

In a sixth aspect, process 800 includes performing each instruction of the one or more instructions successfully, transmitting the second indication includes transmitting a manage UE policy command complete message that indicates, as the synchronization state, a synchronized state.

In a seventh aspect, process 800 includes failing to perform at least one instruction of the one or more instructions successfully, transmitting the second indication includes transmitting a manage UE reject message that indicates, as the synchronized state, an unsynchronized state.

In an eighth aspect, transmitting the second indication includes performing a manage UE policy procedure, transmitting the second indication includes transmitting a UE state indication based at least in part on completion of the manage UE policy procedure.

In a ninth aspect, process 800 includes receiving a manage UE policy command message, and detecting, as the synchronization state and based at least in part on the manage UE policy command message, an unsynchronized state between the UE-local policy identifier information the PCF policy identifier information, transmitting the second indication includes transmitting the second indication based at least in part on detecting the unsynchronized state.

In a tenth aspect, detecting the unsynchronized state includes detecting that the UE-local policy identifier information does not include a policy section identifier that is indicated by the manage UE policy command message.

In an eleventh aspect, the manage UE policy command message indicates to add a policy section identifier to the UE-local policy identifier information, and detecting the unsynchronized state includes detecting, prior to adding the policy section identifier to the UE-local policy identifier information, that the UE-local policy identifier information includes a maximum number of entries.

In a twelfth aspect, detecting the unsynchronized state includes detecting that a location associated with the UE satisfies a distance threshold.

In a thirteenth aspect, detecting the unsynchronized state includes detecting that a configuration of the UE-local policy identifier information has remained unchanged for a duration that satisfies a time threshold.

In a fourteenth aspect, detecting the unsynchronized state includes detecting that the UE-local policy identifier information does not include a tuple identifier that is associated with a current visited PLMN and is indicated by the manage UE policy command message.

In a fifteenth aspect, the manage UE policy command message indicates to add a tuple identifier to the UE-local policy identifier information, and detecting the unsynchronized state includes detecting, prior to adding the tuple identifier to the UE-local policy identifier information, that the UE-local policy identifier information includes a maximum number of entries.

In a sixteenth aspect, the UE-local policy identifier information is empty, and process 800 includes receiving a third indication of a policy identifier to store in the UE-local policy identifier information, and determining, as the synchronization state, a synchronized state between the UE-local policy identifier information and the PCF policy information based at least in part on the UE-local policy identifier information being empty.

In a seventeenth aspect, process 800 includes detecting zero mismatches between the UE-local policy identifier information and the PCF policy identifier information, and determining, as the synchronization state, a synchronized state between the UE-local policy identifier information and the PCF policy information based at least in part on detecting the zero mismatches.

In an eighteenth aspect, the synchronization state is a synchronized state, and transmitting the second indication of the synchronization state includes transmitting an empty UPSI list to indicate the synchronized state.

In a nineteenth aspect, the first indication specifies to report, as the UE-local policy identifier information, tuple policy information, and process 800 includes receiving a policy section instruction, identifying a tuple in the UE-local policy identifier information that is affected by the policy section instruction, and transmitting, as the tuple policy information, a tuple identifier associated with the tuple that is affected by the policy section instruction.

In a twentieth aspect, the first indication specifies to report, as the UE-local policy identifier information, tuple policy information, and process 800 includes receiving a policy section instruction, identifying that no tuple in the UE-local policy identifier information is affected by the policy section instruction, and transmitting an empty tuple identifier list to indicate, as the synchronization state, a synchronized state.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with synchronizing a PCF with a UE.

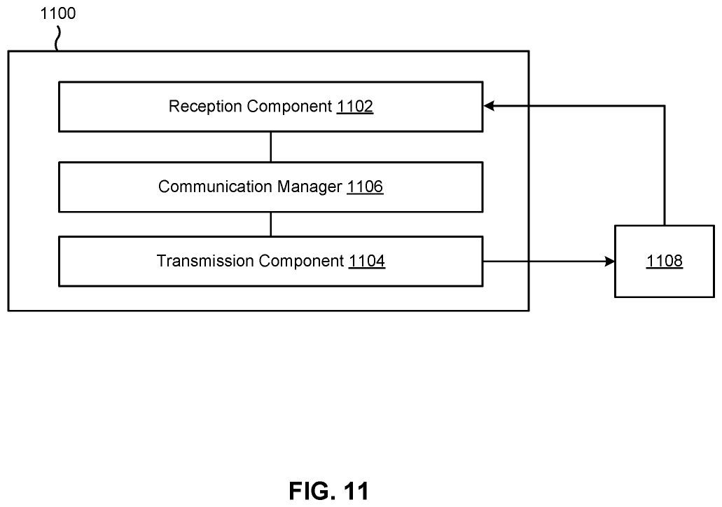

As shown in FIG. 9, in some aspects, process 900 may include transmitting a first indication to report UE-local policy identifier information that is based at least in part on a PCF that is associated with a wireless network (block 910). For example, the network node (e.g., using transmission component 1104 and/or communication manager 1106, depicted in FIG. 11) may transmit a first indication to report UE-local policy identifier information that is based at least in part on a PCF that is associated with a wireless network, as described above.

As further shown in FIG. 9, in some aspects, process 900 may include receiving a second indication of a synchronization state between the UE-local policy identifier information and PCF policy identifier information (block 920). For example, the network node (e.g., using reception component 1102 and/or communication manager 1106, depicted in FIG. 11) may receive a second indication of a synchronization state between the UE-local policy identifier information and PCF policy identifier information, as described above.

Process 900 may include additional aspects, such as any single aspect or any combination of aspects described below and/or in connection with one or more other processes described elsewhere herein.

In a first aspect, transmitting the first indication includes transmitting a manage UE policy command message that includes a UE policy network classmark IE, and the UE policy network classmark IE includes the first indication.

In a second aspect, the UE policy network classmark IE includes a UPSRI field, and the first indication includes the UPSRI field being set to a value that indicates to report one or more policy section identifiers included in the UE-local policy identifier information.

In a third aspect, the UE policy network classmark IE includes a VPSTRI field, and the first indication includes the VPSTRI field being set to a value that indicates to report one or more tuple identifiers included in the UE-local policy identifier information.

In a fourth aspect, the value indicates to report a first tuple identifier that is associated with a current PLMN, and the value indicates to not report a second tuple identifier that is associated with a non-current PLMN.

In a fifth aspect, process 900 includes transmitting, as at least part of a manage UE policy command message, a third indication of one or more instructions that are associated with the UE-local policy identifier information.

In a sixth aspect, receiving the second indication includes receiving a manage UE policy command complete message that indicates, as the synchronization state, a synchronized state.

In a seventh aspect, receiving the second indication includes receiving a manage UE reject message that indicates, as the synchronized state, an unsynchronized state.

In an eighth aspect, the one or more instructions include an instruction to perform a manage UE policy procedure, and receiving the second indication includes receiving a UE state indication based at least in part on completion of the manage UE policy procedure.

In a ninth aspect, process 900 includes determining that the synchronization state between the UE-local policy identifier information and the PCF policy identifier information is an unsynchronized state based at least in part on receiving the second indication.

In a tenth aspect, receiving the second indication of the synchronization state includes receiving an empty UPSI list, and determining, as the synchronization state, a synchronized state based at least in part on receiving the empty UPSI list.

In an eleventh aspect, the first indication specifies to report, as the UE-local policy identifier information, tuple policy information, and process 900 includes transmitting a policy section instruction, receiving, as the tuple policy information, a tuple identifier, and determining that a tuple associated with the tuple identifier is affected by the policy section instruction based at least in part on receiving the tuple identifier.

In a twelfth aspect, process 900 includes transmitting a policy section instruction, receiving an empty tuple identifier list, and determining, as the synchronization state, a synchronized state based at least in part on receiving the empty tuple identifier list.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-9. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a first indication to report UE-local policy identifier information that is based at least in part on a PCF associated with a wireless network. The transmission component 1004 may transmit a second indication of a synchronization state between the UE-local policy identifier information and PCF policy identifier information. Alternatively, or additionally, the reception component 1002 may receive, as at least part of a manage UE policy command message, a third indication of one or more instructions that are associated with the UE-local policy identifier information and transmitting the second indication is based at least in part on the one or more instructions. The communication manager 1006 may perform each instruction of the one or more instructions successfully (e.g., without error). Alternatively, or additionally the communication manager 1006 may fail to perform at least one instruction of the one or more instructions successfully.

The reception component 1002 may receive a manage UE policy command message. In some aspects, the communication manager 1006 may detect, as the synchronization state and based at least in part on the manage UE policy command message, an unsynchronized state between the UE-local policy identifier information the PCF policy identifier information. Alternatively, or additionally, the communication manager 1006 may detect zero mismatches between the UE-local policy identifier information and the PCF policy identifier information and/or the communication manager 1006 may determine, as the synchronization state, a synchronized state between the UE-local policy identifier information and the PCF policy information based at least in part on detecting the zero mismatches.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-9. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a first indication to report UE-local policy identifier information that is based at least in part on a PCF that is associated with a wireless network. The reception component 1102 may receive a second indication of a synchronization state between the UE-local policy identifier information and PCF policy identifier information.

The transmission component 1104 may transmit, as at least part of a manage UE policy command message, a third indication of one or more instructions that are associated with the UE-local policy identifier information. Alternatively, or additionally, the communication manager 1106 may determine that the synchronization state between the UE-local policy identifier information and the PCF policy identifier information is an unsynchronized state based at least in part on receiving the second indication.

The transmission component 1104 may transmit a policy section instruction and/or the reception component 1102 may receive an empty tuple identifier list. In some aspects, the communication manager 1106 may determine, as the synchronization state, a synchronized state based at least in part on receiving the empty tuple identifier list.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a first indication to report UE-local policy identifier information that is based at least in part on a policy control function (PCF) associated with a wireless network; and transmitting a second indication of a synchronization state between the UE-local policy identifier information and PCF policy identifier information.

Aspect 2: The method of Aspect 1, wherein receiving the first indication comprises: receiving a manage UE policy command message that includes a UE policy network classmark information element (IE), wherein the UE policy network classmark IE includes the first indication.

Aspect 3: The method of Aspect 2, wherein the UE policy network classmark IE includes a UE policy section reporting indicator (UPSRI) field, and wherein the first indication comprises the UPSRI field being set to a value that indicates to report one or more policy section identifiers included in the UE-local policy identifier information.

Aspect 4: The method of Aspect 2, wherein the UE policy network classmark IE includes a visited public land mobile network specific tuple policy reporting indicator (VPSTRI) field, and wherein the first indication comprises the VPSTRI field being set to a value that indicates to report one or more tuple identifiers included in the UE-local policy identifier information.

Aspect 5: The method of Aspect 4, wherein the value indicates to report a first tuple identifier that is associated with a current public land mobile network (PLMN), and wherein the value indicates to not report a second tuple identifier that is associated with a non-current PLMN.

Aspect 6: The method of any of Aspects 1-5, further comprising: receiving, as at least part of a manage UE policy command message, a third indication of one or more instructions that are associated with the UE-local policy identifier information, wherein transmitting the second indication is based at least in part on the one or more instructions.

Aspect 7: The method of Aspect 6, further comprising: performing each instruction of the one or more instructions successfully, wherein transmitting the second indication comprises: transmitting a manage UE policy command complete message that indicates, as the synchronization state, a synchronized state, wherein transmitting the second indication comprises: transmitting a manage UE policy command complete message that indicates, as the synchronization state, a synchronized state.

Aspect 8: The method of Aspect 6, further comprising: failing to perform at least one instruction of the one or more instructions successfully, wherein transmitting the second indication comprises: transmitting a manage UE reject message that indicates, as the synchronized state, an unsynchronized state, wherein transmitting the second indication comprises: transmitting a manage UE reject message that indicates, as the synchronized state, an unsynchronized state.

Aspect 9: The method of Aspect 6, wherein transmitting the second indication comprises: performing a manage UE policy procedure, wherein transmitting the second indication comprises: transmitting a UE state indication based at least in part on completion of the manage UE policy procedure.

Aspect 10: The method of any of Aspects 1-9, further comprising: receiving a manage UE policy command message; and detecting, as the synchronization state and based at least in part on the manage UE policy command message, an unsynchronized state between the UE-local policy identifier information the PCF policy identifier information, wherein transmitting the second indication comprises: transmitting the second indication based at least in part on detecting the unsynchronized state, wherein transmitting the second indication comprises: transmitting the second indication based at least in part on detecting the unsynchronized state.

Aspect 11: The method of Aspect 10, wherein detecting the unsynchronized state comprises: detecting that the UE-local policy identifier information does not include a policy section identifier that is indicated by the manage UE policy command message.

Aspect 12: The method of Aspect 10, wherein the manage UE policy command message indicates to add a policy section identifier to the UE-local policy identifier information, and wherein detecting the unsynchronized state comprises: detecting, prior to adding the policy section identifier to the UE-local policy identifier information, that the UE-local policy identifier information includes a maximum number of entries.

Aspect 13: The method of Aspect 10, wherein detecting the unsynchronized state comprises: detecting that a location associated with the UE satisfies a distance threshold.

Aspect 14: The method of Aspect 10, wherein detecting the unsynchronized state comprises: detecting that a configuration of the UE-local policy identifier information has remained unchanged for a duration that satisfies a time threshold.

Aspect 15: The method of Aspect 10, wherein detecting the unsynchronized state comprises: detecting that the UE-local policy identifier information does not include a tuple identifier that is associated with a current visited public land mobile network (PLMN) and is indicated by the manage UE policy command message.

Aspect 16: The method of Aspect 10, wherein the manage UE policy command message indicates to add a tuple identifier to the UE-local policy identifier information, and wherein detecting the unsynchronized state comprises: detecting, prior to adding the tuple identifier to the UE-local policy identifier information, that the UE-local policy identifier information includes a maximum number of entries.

Aspect 17: The method of any of Aspects 1-16, wherein the UE-local policy identifier information is empty, and the method further comprises: receiving a third indication of a policy identifier to store in the UE-local policy identifier information; and determining, as the synchronization state, a synchronized state between the UE-local policy identifier information and the PCF policy information based at least in part on the UE-local policy identifier information being empty.

Aspect 18: The method of any of Aspects 1-17, further comprising: detecting zero mismatches between the UE-local policy identifier information and the PCF policy identifier information; and determining, as the synchronization state, a synchronized state between the UE-local policy identifier information and the PCF policy information based at least in part on detecting the zero mismatches.

Aspect 19: The method of any of Aspects 1-18, wherein the synchronization state is a synchronized state, and wherein transmitting the second indication of the synchronization state comprises: transmitting an empty UE policy section identifier (UPSI) list to indicate the synchronized state.

Aspect 20: The method of any of Aspects 1-19, wherein the first indication specifies to report, as the UE-local policy identifier information, tuple policy information, and the method further comprises: receiving a policy section instruction; identifying a tuple in the UE-local policy identifier information that is affected by the policy section instruction; and transmitting, as the tuple policy information, a tuple identifier associated with the tuple that is affected by the policy section instruction.

Aspect 21: The method of any of Aspects 1-20, wherein the first indication specifies to report, as the UE-local policy identifier information, tuple policy information, and the method further comprises: receiving a policy section instruction; identifying that no tuple in the UE-local policy identifier information is affected by the policy section instruction; and transmitting an empty tuple identifier list to indicate, as the synchronization state, a synchronized state.

Aspect 22: A method of wireless communication performed by a network node, comprising: transmitting a first indication to report user equipment-local (UE-local) policy identifier information that is based at least in part on a policy control function (PCF) that is associated with a wireless network; and receiving a second indication of a synchronization state between the UE-local policy identifier information and PCF policy identifier information.

Aspect 23: The method of Aspect 22, wherein transmitting the first indication comprises: transmitting a manage UE policy command message that includes a UE policy network classmark information element (IE), wherein the UE policy network classmark IE includes the first indication.

Aspect 24: The method of Aspect 23, wherein the UE policy network classmark IE includes a UE policy section reporting indicator (UPSRI) field, and wherein the first indication comprises the UPSRI field being set to a value that indicates to report one or more policy section identifiers included in the UE-local policy identifier information.

Aspect 25: The method of Aspect 24, wherein the UE policy network classmark IE includes a visited public land mobile network specific tuple policy reporting indicator (VPSTRI) field, and wherein the first indication comprises the VPSTRI field being set to a value that indicates to report one or more tuple identifiers included in the UE-local policy identifier information.

Aspect 26: The method of Aspect 25, wherein the value indicates to report a first tuple identifier that is associated with a current public land mobile network (PLMN), and wherein the value indicates to not report a second tuple identifier that is associated with a non-current PLMN.

Aspect 27: The method of any of Aspects 22-26, further comprising: transmitting, as at least part of a manage UE policy command message, a third indication of one or more instructions that are associated with the UE-local policy identifier information.

Aspect 28: The method of Aspect 27, wherein receiving the second indication comprises: receiving a manage UE policy command complete message that indicates, as the synchronization state, a synchronized state.

Aspect 29: The method of Aspect 27, wherein receiving the second indication comprises: receiving a manage UE reject message that indicates, as the synchronized state, an unsynchronized state.

Aspect 30: The method of Aspect 27, wherein the one or more instructions include an instruction to perform a manage UE policy procedure, and wherein receiving the second indication comprises: receiving a UE state indication based at least in part on completion of the manage UE policy procedure.

Aspect 31: The method of any of Aspects 22-30, further comprising: determining that the synchronization state between the UE-local policy identifier information and the PCF policy identifier information is an unsynchronized state based at least in part on receiving the second indication.

Aspect 32: The method of any of Aspects 22-31, wherein receiving the second indication of the synchronization state comprises: receiving an empty UE policy section identifier (UPSI) list; and determining, as the synchronization state, a synchronized state based at least in part on receiving the empty UPSI list.

Aspect 33: The method of any of Aspects 22-32, wherein the first indication specifies to report, as the UE-local policy identifier information, tuple policy information, and the method further comprises: transmitting a policy section instruction; receiving, as the tuple policy information, a tuple identifier; and determining that a tuple associated with the tuple identifier is affected by the policy section instruction based at least in part on receiving the tuple identifier.

Aspect 34: The method of any of Aspects 22-33 wherein the first indication specifies to report, as the UE-local policy identifier information, tuple policy information, and the method further comprises: transmitting a policy section instruction; receiving an empty tuple identifier list; and determining, as the synchronization state, a synchronized state based at least in part on receiving the empty tuple identifier list.

Aspect 35: An apparatus for wireless communication at a device, the apparatus comprising one or more processors; one or more memories coupled with the one or more processors; and instructions stored in the one or more memories and executable by the one or more processors, individually or collectively, to cause the apparatus to perform the method of one or more of Aspects 1-21.

Aspect 36: An apparatus for wireless communication at a device, the apparatus comprising one or more memories and one or more processors coupled to the one or more memories, the one or more processors configured, individually or collectively, to cause the device to perform the method of one or more of Aspects 1-21.

Aspect 37: An apparatus for wireless communication, the apparatus comprising at least one means for performing the method of one or more of Aspects 1-21.

Aspect 38: A non-transitory computer-readable medium storing code for wireless communication, the code comprising instructions executable by one or more processors to perform the method of one or more of Aspects 1-21.

Aspect 39: A non-transitory computer-readable medium storing a set of instructions for wireless communication, the set of instructions comprising one or more instructions that, when executed by one or more processors of a device, cause the device to perform the method of one or more of Aspects 1-21.

Aspect 40: A device for wireless communication, the device comprising a processing system that includes one or more processors and one or more memories coupled with the one or more processors, the processing system configured to cause the device to perform the method of one or more of Aspects 1-21.

Aspect 41: An apparatus for wireless communication at a device, the apparatus comprising one or more processors; one or more memories coupled with the one or more processors; and instructions stored in the one or more memories and executable by the one or more processors, individually or collectively, to cause the apparatus to perform the method of one or more of Aspects 22-34.

Aspect 42: An apparatus for wireless communication at a device, the apparatus comprising one or more memories and one or more processors coupled to the one or more memories, the one or more processors configured, individually or collectively, to cause the device to perform the method of one or more of Aspects 22-34.

Aspect 43: An apparatus for wireless communication, the apparatus comprising at least one means for performing the method of one or more of Aspects 1-34.

Aspect 44: A non-transitory computer-readable medium storing code for wireless communication, the code comprising instructions executable by one or more processors to perform the method of one or more of Aspects 22-34.

Aspect 45: A non-transitory computer-readable medium storing a set of instructions for wireless communication, the set of instructions comprising one or more instructions that, when executed by one or more processors of a device, cause the device to perform the method of one or more of Aspects 22-34.

Aspect 46: A device for wireless communication, the device comprising a processing system that includes one or more processors and one or more memories coupled with the one or more processors, the processing system configured to cause the device to perform the method of one or more of Aspects 22-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured, individually or collectively, to:
receive a first indication to report UE-local policy identifier information that is based at least in part on a policy control function (PCF) associated with a wireless network; and
transmit a second indication of a synchronization state between the UE-local policy identifier information and PCF policy identifier information.

2. The apparatus of claim 1, wherein the one or more processors, to receive the first indication, are configured to:
receive a manage UE policy command message that includes a UE policy network classmark information element (IE), wherein the UE policy network classmark IE includes the first indication.

3. The apparatus of claim 2, wherein the UE policy network classmark IE includes a UE policy section reporting indicator (UPSRI) field, and
wherein the first indication comprises the UPSRI field being set to a value that indicates to report one or more policy section identifiers included in the UE-local policy identifier information.

4. The apparatus of claim 2, wherein the UE policy network classmark IE includes a visited public land mobile network specific tuple policy reporting indicator (VPSTRI) field, and
wherein the first indication comprises the VPSTRI field being set to a value that indicates to report one or more tuple identifiers included in the UE-local policy identifier information.

5. The apparatus of claim 1, wherein the one or more processors are further configured to:
receive, as at least part of a manage UE policy command message, a third indication of one or more instructions that are associated with the UE-local policy identifier information,
wherein transmitting the second indication is based at least in part on the one or more instructions.

6. The apparatus of claim 5, wherein the one or more processors are further configured to:
perform each instruction of the one or more instructions successfully,
wherein the one or more processors, to transmit the second indication, are configured to:
transmit a manage UE policy command complete message that indicates, as the synchronization state, a synchronized state based at least in part on each instruction being performed successfully.

7. The apparatus of claim 5, wherein the one or more processors are further configured to:
fail to perform at least one instruction of the one or more instructions successfully,
wherein the one or more processors, to transmit the second indication, are configured to:
transmit a manage UE reject message that indicates, as the synchronized state, an unsynchronized state based at least in part on failing to perform the at least in instruction successfully.

8. The apparatus of claim 5, wherein the one or more processors, to transmit the second indication, are configured to:
perform a manage UE policy procedure,
wherein the one or more processors, to transmit the second indication, are configured to:
transmit a UE state indication based at least in part on completion of the manage UE policy procedure.

9. The apparatus of claim 1, wherein the one or more processors are further configured to:
receive a manage UE policy command message; and
detect, as the synchronization state and based at least in part on the manage UE policy command message, an unsynchronized state between the UE-local policy identifier information the PCF policy identifier information,
wherein the one or more processors, to transmit the second indication, are configured to:
transmit the second indication based at least in part on detecting the unsynchronized state.

10. The apparatus of claim 9, wherein the one or more processors, to detect the unsynchronized state, are configured to:
detect that a configuration of the UE-local policy identifier information has remained unchanged for a duration that satisfies a time threshold.

11. The apparatus of claim 1, wherein the one or more processors are further configured to:
receive a third indication of a policy identifier to store in the UE-local policy identifier information; and
determine, as the synchronization state, a synchronized state between the UE-local policy identifier information and the PCF policy information based at least in part on the UE-local policy identifier information being empty.

12. The apparatus of claim 1, wherein the one or more processors are further configured to:
detect zero mismatches between the UE-local policy identifier information and the PCF policy identifier information; and
determine, as the synchronization state, a synchronized state between the UE-local policy identifier information and the PCF policy information based at least in part on detecting the zero mismatches.

13. The apparatus of claim 1, wherein the synchronization state is a synchronized state, and wherein the one or more processors, to transmit the second indication of the synchronization state, are configured to:
transmit an empty UE policy section identifier (UPSI) list to indicate the synchronized state.

14. The apparatus of claim 1, wherein the first indication specifies to report, as the UE-local policy identifier information, tuple policy information, and
wherein the one or more processors are further configured to:
receive a policy section instruction;
identify a tuple in the UE-local policy identifier information that is affected by the policy section instruction; and
transmit, as the tuple policy information, a tuple identifier associated with the tuple that is affected by the policy section instruction.

15. The apparatus of claim 1, wherein the one or more processors are further configured to:
receive a policy section instruction;
identify that no tuple in the UE-local policy identifier information is affected by the policy section instruction; and
transmit an empty tuple identifier list to indicate, as the synchronization state, a synchronized state.

16. An apparatus for wireless communication at a network node, comprising:
one or more memories; and
one or more processors, coupled to the one or more memories, configured, individually or collectively, to:
transmit a first indication to report user equipment-local (UE-local) policy identifier information that is based at least in part on a policy control function (PCF) that is associated with a wireless network; and
receive a second indication of a synchronization state between the UE-local policy identifier information and PCF policy identifier information.

17. The apparatus of claim 16, wherein the one or more processors, to transmit the first indication, are configured to:
transmit a manage UE policy command message that includes a UE policy network classmark information element (IE), wherein the UE policy network classmark IE includes the first indication.

18. The apparatus of claim 17, wherein the UE policy network classmark IE includes a UE policy section reporting indicator (UPSRI) field, and
wherein the first indication comprises the UPSRI field being set to a value that indicates to report one or more policy section identifiers included in the UE-local policy identifier information.

19. The apparatus of claim 17, wherein the UE policy network classmark IE includes a visited public land mobile network specific tuple policy reporting indicator (VPSTRI) field, and
wherein the first indication comprises the VPSTRI field being set to a value that indicates to report one or more tuple identifiers included in the UE-local policy identifier information.

20. The apparatus of claim 16, wherein the one or more processors are further configured to:
transmit, as at least part of a manage UE policy command message, a third indication of one or more instructions that are associated with the UE-local policy identifier information.

21. The apparatus of claim 16, wherein the one or more processors, to receive the second indication, are configured to:
receive a manage UE policy command complete message that indicates, as the synchronization state, a synchronized state.

22. The apparatus of claim 16, wherein the one or more processors, to receive the second indication, are configured to:
receive a manage UE reject message that indicates, as the synchronized state, an unsynchronized state.

23. The apparatus of claim 16, wherein the one or more processors are further configured to:
determine that the synchronization state between the UE-local policy identifier information and the PCF policy identifier information is an unsynchronized state based at least in part on receiving the second indication.

24. The apparatus of claim 16, wherein the one or more processors, to receive the second indication of the synchronization state, are configured to:
receive an empty UE policy section identifier (UPSI) list; and
determine, as the synchronization state, a synchronized state based at least in part on receiving the empty UPSI list.

25. The apparatus of claim 16, wherein the first indication specifies to report, as the UE-local policy identifier information, tuple policy information, and
wherein the one or more processors are further configured to:
transmit a policy section instruction;
receive, as the tuple policy information, a tuple identifier; and
determine that a tuple associated with the tuple identifier is affected by the policy section instruction based at least in part on receiving the tuple identifier.

26. The apparatus of claim 16, wherein the first indication specifies to report, as the UE-local policy identifier information, tuple policy information, and wherein the one or more processors are further configured to:
transmit a policy section instruction;
receive an empty tuple identifier list; and
determine, as the synchronization state, a synchronized state based at least in part on receiving the empty tuple identifier list.

27. A method of wireless communication performed by a user equipment (UE), comprising:
receiving a first indication to report UE-local policy identifier information that is based at least in part on a policy control function (PCF) associated with a wireless network; and
transmitting a second indication of a synchronization state between the UE-local policy identifier information and PCF policy identifier information.

28. The method of claim 27, wherein receiving the first indication comprises:
receiving a manage UE policy command message that includes a UE policy network classmark information element (IE), wherein the UE policy network classmark IE includes the first indication.

29. A method of wireless communication performed by a network node, comprising:
transmitting a first indication to report user equipment-local (UE-local) policy identifier information that is based at least in part on a policy control function (PCF) that is associated with a wireless network; and
receiving a second indication of a synchronization state between the UE-local policy identifier information and PCF policy identifier information.

30. The method of claim 29, wherein transmitting the first indication comprises:
transmitting a manage UE policy command message that includes a UE policy network classmark information element (IE), wherein the UE policy network classmark IE includes the first indication.
